(19) United States
(12) Patent Application Publication
(10) Pub. No.: US 2025/0166410 A1
(43) Pub. Date: May 22, 2025

(54) SYSTEMS AND METHODS FOR MULTI-DOMAIN FACIAL LANDMARK DETECTION

(71) Applicant: Datum Point Labs Inc., Jackson, WY (US)

(72) Inventors: Yuanming Li, Seoul (KR); Hanseok Ko, Seoul (KR); Bonhwa Ku, Seoul (KR)

(21) Appl. No.: 18/953,686

(22) Filed: Nov. 20, 2024

Related U.S. Application Data
(60) Provisional application No. 63/601,980, filed on Nov. 22, 2023.

(51) Int. Cl. G06V 40/16; G06V 10/774

(52) U.S. Cl. CPC G06V 40/166; G06V 10/774

(57) ABSTRACT

Embodiments described herein provide systems and methods for multi-domain facial landmark detection. An image generation model is trained using a dataset with images from multiple domains and corresponding landmarks and prompts indicating the style of the images. The trained image generation model is used to generate a synthetic dataset including a large number of image/landmark pairs in a variety of styles. The image/landmark pairs of the synthetic dataset are used to train a multi-domain landmark detector.

### TECHNICAL FIELD

The embodiments relate generally to systems and methods for facial landmark detection.

### BACKGROUND

Recent advancements in deep learning have led to significant improvements in facial landmark detection for faces in real-world settings. However, challenges persist in extending this capability to diverse domains such as cartoons and caricatures due to limited annotated training data. Therefore, there is a need for systems and methods for multi-domain facial landmark detection.

### BRIEF DESCRIPTION OF THE DRAWINGS

FIG. 1 illustrates an exemplary framework for training a multi-domain landmark detector, according to some embodiments.

FIG. 2 is a simplified diagram illustrating a computing device implementing the framework described in FIG. 1, according to some embodiments.

FIG. 3 is a simplified block diagram of a networked system suitable for implementing the framework described in FIG. 1 and other embodiments described herein.

FIG. 4 is a simplified diagram illustrating an exemplary training framework for a denoising diffusion model.

### DETAILED DESCRIPTION

Recent advancements in deep learning have led to significant improvements in facial landmark detection for faces in real-world settings. However, challenges persist in extending this capability to diverse domains such as cartoons and caricatures due to limited annotated training data. Multi-domain images may include cartoon, art face, and real face domains. These domains and others deal with datasets or scenarios where images belong to different visual styles or categories. Each of these styles-cartoon, art face, and real face-represents a distinct domain, and a multi-domain approach involves developing models that can effectively handle and understand the characteristics of images from each of these domains.

Embodiments described herein provide systems and methods for multi-domain facial landmark detection. First, a denoising diffusion model is trained/fine-tuned via a two-stage training approach leveraging a pre-trained diffusion model and small annotated datasets. In the first stage, a landmark-conditioned face generation model is trained on a large dataset of real faces. The second stage involves fine-tuning this model on a smaller dataset of image-landmark pairs with text prompts to control the domain. Utilizing the fine-tuned denoising diffusion model, a large number of multi-domain image/landmark pairs may be generated to provide a synthetic dataset. The synthetic dataset, which includes image/landmark pairs in a number of domains, is used to train a multi-domain landmark detector. At inference, the multi-domain landmark detector may be provided an image as an input which is from a number of domains (including domains in the synthetic dataset, and unseen domains), and generate a facial landmark prediction for the input image. The generated facial landmark prediction may be used in other subsequent tasks, such as three-dimensional reconstruction of cartoon faces.

This approach allows the generation of high-quality synthetic paired datasets across multiple domains while maintaining alignment between landmarks and facial features. Fine-tuning a pre-trained landmark detection model on this dataset enables domain-agnostic face landmark detection. Evaluation studies demonstrate that methods described herein extend existing techniques to achieve effective multi-domain face landmark detection.

Embodiments described herein address the challenge of multi domains facial landmark detection tasks, such as cartoons and caricatures. Specifically, the main problem solved is the difficulty in achieving accurate facial landmark detection in these alternative domains due to the scarcity of annotated training data. The current face landmark detection methods exhibit satisfactory results for detecting landmarks on real human faces. However, when it comes to face landmark detection in other domains such as cartoons, the performance is not as satisfactory.

Embodiments described herein provide a number of benefits. For example, the two-stage training approach leverages a pre-trained diffusion model and a small dataset with text prompts, efficiently generating high-quality synthetic paired datasets for multi-domain face landmark detection. This flexibility extends to precise control over geometric characteristics and styles of face images through landmark and text prompt editing. Despite the challenge of limited annotated training data, methods described herein excel in achieving domain-agnostic face landmark detection and demonstrate state-of-the-art performance, particularly on challenging image styles such as cartoons and caricatures. Embodiments described herein therefore provide a robust solution for accurate and adaptable multi-domain face landmark detection.

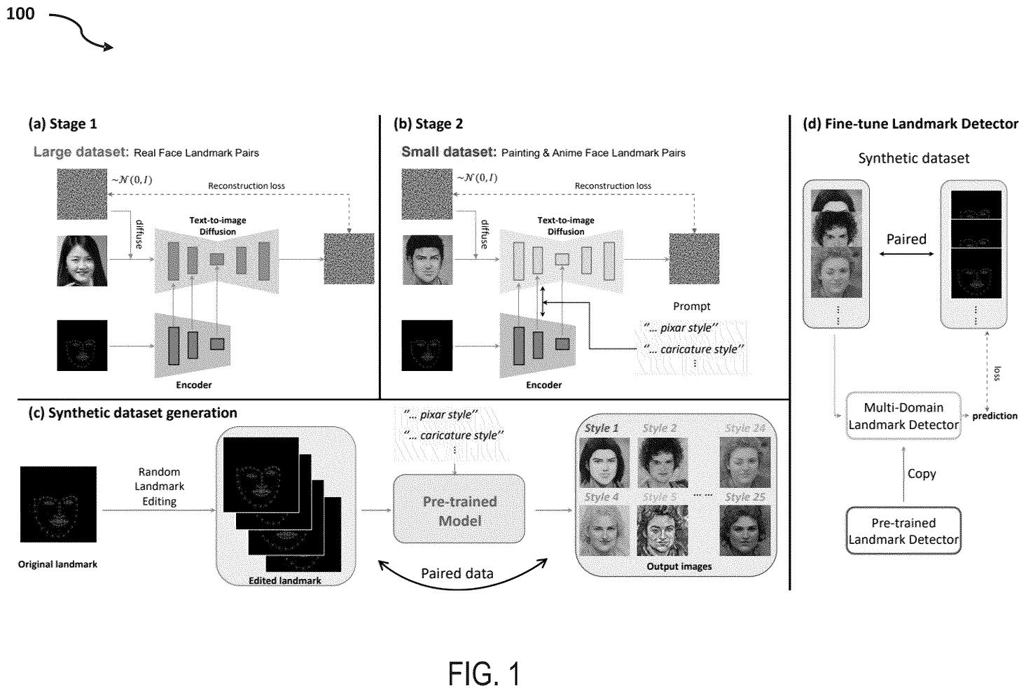

FIG. 1 illustrates an exemplary framework 100 for training a multi-domain landmark detector, according to some embodiments. Framework 100 includes multiple stages which result in a trained multi-domain landmark detector which may be used to predict facial landmarks of input images from multiple domains (e.g., photos, caricatures, cartoons, etc.). The first two stages illustrated train a denoising diffusion model that may be used in generating images of faces corresponding to a conditioning facial landmark and a prompt indicating a domain/style.

In stage 1 (step a of FIG. 1), a pre-trained diffusion model is employed, trained on a large dataset of real-world faces. This model uses facial landmarks as a condition for generating face images, ensuring alignment between landmarks and facial features. The pre-trained diffusion model may utilize an encoder which receives a landmark as an input, and internal layers of the encoder may be used to condition layers of the diffusion model such that the landmark conditions the generation of an image. For example, the pre-trained diffusion model may generate an image of a face which corresponds to the input landmark. The training dataset may include real face and landmark pairs which are known-good pairs. A reconstruction loss may be used to update parameters of the pre-trained diffusion model and/or the encoder. In some embodiments, the encoder is (or is initialized as) a copy of an encoder portion of the pre-trained diffusion model. As used herein, the diffusion model may be considered to include the encoder, and therefore the diffusion model receives as inputs a noisy input image, a conditioning image, and a text prompt, and outputs a denoised image conditioned by the conditioning image (i.e., landmark) and text prompt.

In stage 2 (step b of FIG. 1), the pre-trained model is fine-tuned using a small multi-domain face dataset, introducing diversity in face images across various domains. This fine-tuning process enhances the model's ability to detect landmarks in diverse image styles. The training dataset for this step may include known-good triplet pairs of images, landmarks, and prompts indicating the style of the image.

Once the diffusion model is trained, it may be used in synthetic dataset generation as shown in step c of FIG. 1. The trained text-to-image diffusion model plays a crucial role in generating synthetic data pairs of multi-domain face images and their corresponding landmarks. This involves translating textual prompts into visual features, facilitating control over geometric characteristics and styles of the generated face images. To generate a large dataset, one or more landmarks may be automatically randomly edited (e.g, by moving or otherwise changing landmark features) to generate a large variety of landmarks. Landmarks may be paired with randomly selected styles (e.g., from a predefined list of styles used in stage 2) and input to the trained diffusion model, which generates output images corresponding to the input landmarks and style prompts. Many image/landmark pairs may be generated with different style images, resulting in a large multi-domain (e.g., multiple styles) synthetic dataset.

The synthetic dataset may be used in step d of FIG. 1 to fine-tune a pre-trained landmark detection model. For example, a landmark detector (i.e., landmark detection model) may be pre-trained for real-world facial landmark detection. The landmark detector, for example, may use a landmark regression method based on a stacked hour-glasses networks (HGs) that generates N heatmaps, each of which is a probability distribution over the predicted facial landmarks. During training, the images from the synthetic dataset may be input to the landmark detector, which generates a predicted landmark based on the input image. The predicted landmark may be compared to the corresponding landmark in the synthetic dataset to compute a loss function. The loss function may be used to update parameters of the landmark detector via backpropagation. The resulting trained multi-domain landmark detector may be provided an image as an input which is from a number of domains (including domains in the synthetic dataset, and unseen domains), and generate a facial landmark prediction for the input image. The generated facial landmark prediction may be used in other subsequent tasks, such as three-dimensional reconstruction of cartoon faces.

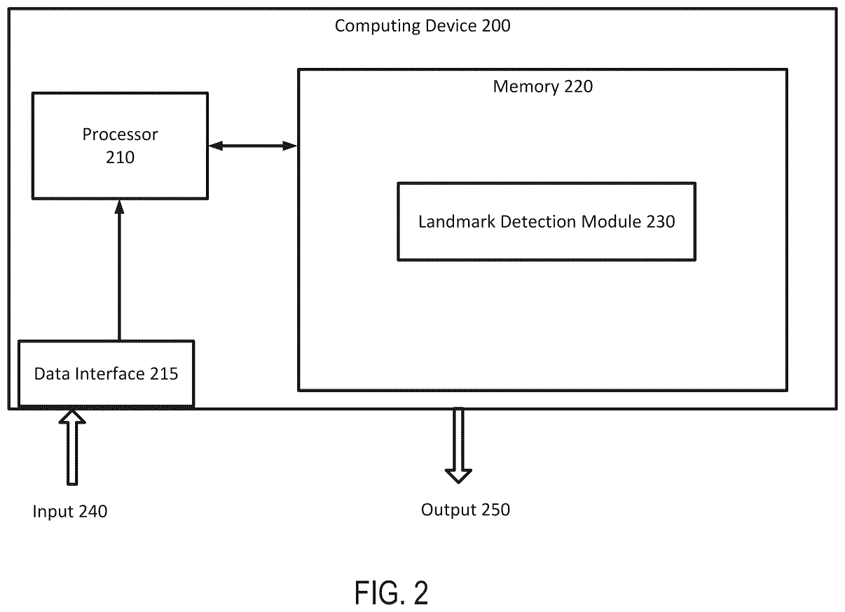

FIG. 2 is a simplified diagram illustrating a computing device 200 implementing the framework described in FIG. 1, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for landmark detection module 230 that may be used to implement and/or emulate the systems and models, and/or to implement any of the methods described further herein. Landmark detection module 230 may receive input 240 such as images and/or landmarks as part of a training dataset and generate an output 250 which may be a facial landmark prediction.

The data interface 215 may comprise a communication interface, a user interface (such as a voice input interface, a graphical user interface, and/or the like). For example, the computing device 200 may receive the input 240 (such as an image of a face) from a networked device via a communication interface. Or the computing device 200 may receive the input 240, such as images, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

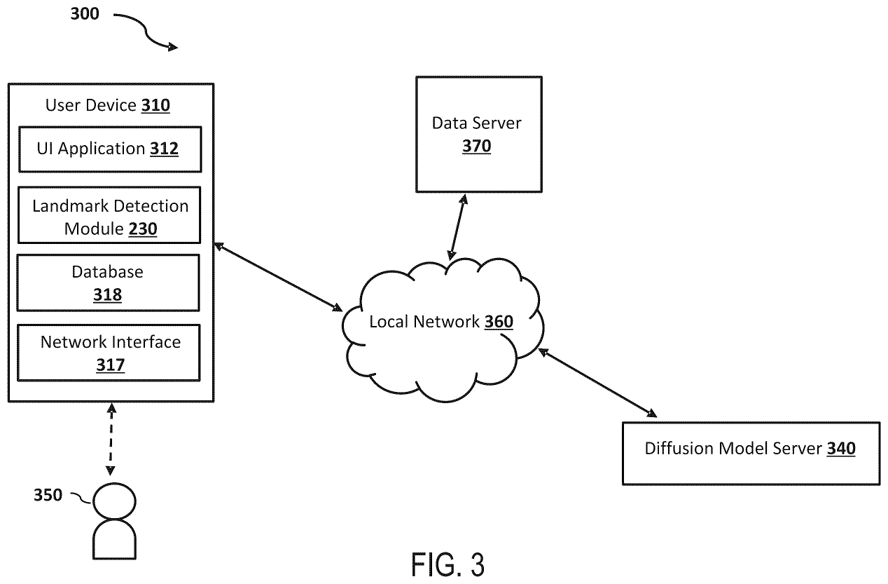

FIG. 3 is a simplified block diagram of a networked system 300 suitable for implementing the framework described in FIG. 1 and other embodiments described herein. In one embodiment, system 300 includes the user device 310 (e.g., computing device 200) which may be operated by user 350, data server 370, diffusion model server 340, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and diffusion model server 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over local network 360.

In some embodiments, all or a subset of the actions described herein may be performed solely by user device 310. In some embodiments, all or a subset of the actions described herein may be performed in a distributed fashion by various network devices, for example as described herein.

User device 310 may be implemented as a communication device that may utilize appropriate hardware and software configured for wired and/or wireless communication with data server 370 and/or the diffusion model server 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and landmark detection module 230, which may correspond to executable processes, procedures, and/or applications with associated hardware. For example, the user device 310 may allow a user to select an image, or take a picture using a camera associated with user device 310. In other embodiments, user device 310 may include additional or different modules having specialized hardware and/or software as required.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data and be utilized during execution of various modules of user device 310. Database 318 may store images, landmark predictions, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or diffusion model server 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store a training dataset including images of faces and facial landmarks as described in FIG. 1.

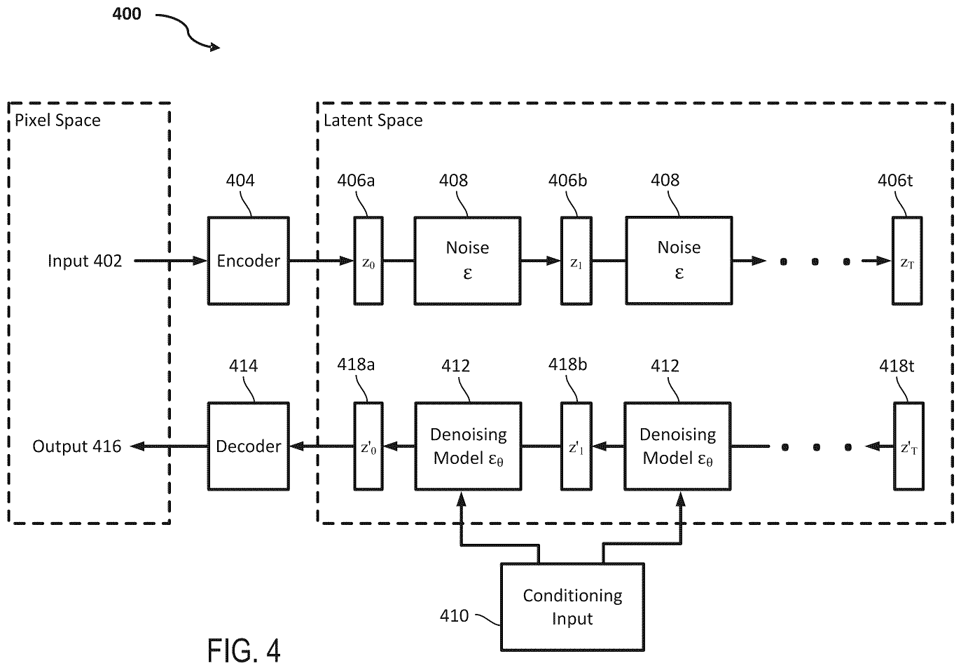

Diffusion model server 340 may be a server that hosts the denoising diffusion model described in FIGS. 1 and 4. Diffusion model server 340 may provide an interface via local network 360 such that user device 310 may provide prompts and conditioning inputs to which are input to a denoising diffusion model (which may include multiple denoising diffusion models as described in FIG. 1) on diffusion model server 340. Diffusion model server 340 may communicate outputs of the diffusion model to user device 310 via local network 360.

FIG. 4 is a simplified diagram illustrating an exemplary training framework 400 for a denoising diffusion model for generating or editing an image given a conditioning input such as a text prompt. In some embodiments, the text-to-image diffusion model described in FIG. 1 may be trained or pre-trained according to training framework 400. In one embodiment, a denoising diffusion model is trained to generate an image (e.g., output 416) based on a user input (e.g., a text prompt in conditioning input 410). At inference, the denoising diffusion model may receive a text prompt describing image content, and start with a random noise vector as a seed vector, and the denoising model progressively removes “noise” from the seed vector as conditioned by the user input (e.g., text prompt) such that the resulting image may gradually align with the user input. Completely removing the noise in a single step would be infeasibly difficult computationally. For this reason, the denoising model is trained to remove a small amount of noise, and the denoising step is repeated iteratively so that over a number of iterations (e.g., 50 iterations), the image eventually becomes clear.

Framework 400 illustrates how such a diffusion model may be trained to generate an image given a prompt by gradually removing noise from a seed vector. The top portion of the illustrated framework 400 including encoder 404 and the noise & 408 steps may only be used during the training process, and not at inference, as described below. A training dataset may include a variety of images, which do not necessarily require any annotations, but may be associated with information such as a caption for each image in the training dataset that may be used as a conditioning input 410. A training image may be used as input 402. Encoder 404 may encode input 402 into a latent representation (e.g., a vector) which represents the image.

In some embodiments, a diffusion model may be trained using the pixel-level data directly. In other embodiments, a diffusion model may be trained on scaled down versions of images. Generally some form of encoder 404, however, is desirable so that the image is in a format which is more easily consumed by the denoising model se 412. The remaining description of framework 400 presumes encoder 404 generates a latent vector representation of input 402.

Latent vector representation z₀ 406a represents the first encoded latent representation of input 402. Noise ε 408 is added to the representation z₀ 406a to produce representation z₁ 406b. Noise ε 408 is then added to representation z₁ 406b to produce an even noisier representation. This process is repeated T times (e.g., 50 iterations) until it results in a noised latent representation z_{T} 406t. The random noise & 408 added at each iteration may be a random sample from a probability distribution such as Gaussian distribution. The amount (i.e., variance) of noise & 408 added at each iteration may be constant, or may vary over the iterations. The amount of noise & 408 added may depend on other factors such as image size or resolution.

This process of incrementally adding noise to latent image representations effectively generates training data that is used in training the diffusion denoising model 412, as described below. As illustrated, denoising model ε_{θ} 412 is iteratively used to reverse the process of noising latents (i.e., perform reverse diffusion) from z′_{T} 418t to z′₀ 418a. Denoising model &e 412 may be a neural network based model, which has parameters that may be learned. Input to denoising model se 412 may include a noisy latent representation (e.g., noised latent representation z_{T} 406t), and conditioning input 410 such as a text prompt describing desired content of an output image, e.g., “a hand holding a globe.” As shown, the noisy latent representation may be repeatedly and progressively fed into denoising model 412 to gradually remove noise from the latent representation vector based on the conditioning input 410, e.g., from z′_{T} 418t to z′₀ 418a.

Ideally, the progressive outputs of repeated denoising models ε_{θ} 412 z′_{T} 418t to z′₀ 418a may be an incrementally denoised version of the input latent representation z′r 418t, as conditioned by a conditioning input 410. The latent image representation produced using denoising model se 412 may be decoded using decoder 414 to provide an output 416 which is the denoised image.

In one embodiment, the output image 416 is then compared with the input training image 402 to compute a loss for updating the denoising model 412 via back propagation. In another embodiment, the latent representation 406a of input 402 may be compared with the denoised latent representation 418a to compute a loss for training. In another embodiment, a loss objective may be computed comparing the noise actually added (e.g., by noise ¿ 408) with the noise predicted by denoising model se 412. Denoising model e 412 may be trained based on this loss objective (e.g., parameters of denoising model se 412 may be updated in order to minimize the loss by gradient descent using backpropagation). Note that this means during the training process of denoising model se 412, an actual denoised image does not necessarily need to be produced (e.g., output 416 of decoder 414), as the loss is based on each intermediate noise estimation, not necessarily the final image.

In one embodiment, conditioning input 410 may include a description of the input image 402, and in this way denoising model se 412 learns to reproduce the image described. Alternatively (or in addition), conditioning input 410 may include a text prompt, a conditioning image, an attention map, or other conditioning inputs. These inputs may be encoded in some way before being used by denoising model ε_{θ} 412. For example, a conditioning image may be encoded using an encoder similar to encoder 404. Conditioning input 410 may also include a time step, which may be used to provide the model with a general estimate of how much noise remains in the image, and the time step may increment (or decrement) for each iteration.

In some embodiments, denoising model se 412 may be implemented through a structure referred to as “U-Net.” The U-Net structure may include a series of convolutional layers and pooling layers which generate progressively lower resolution multi-channel feature maps. Each pooling layer and an associated one or more convolutional layers may be considered an encoder. The convolutional and pooling layers (i.e., encoders) may be followed by a series of up-sampling layers and convolutional layers which generate progressively higher resolution multi-channel feature maps. Each up-sampling layer and an associated one or more convolutional layers may be considered a decoder. The U-Net may also include skip connections, where outputs of each encoder layer are concatenated with the corresponding decoder layer, skipping the intermediate encoder/decoder layers. Skip connections allow information about the precise location of features extracted by convolutional (encoder) layers. The convolutional kernels for convolution layers, and up-sampling functions for the up-sampling layers may be learned during a training process. Conditioning inputs (e.g., images or a natural language prompt) may be used to condition the function of a U-Net. For example, conditioning inputs may be encoded and cross-attention may be applied between the encoded conditioning inputs and the feature maps at the encoder/decoder layers.

The direct output of denoising model so 412 (e.g., when implemented as a U-Net) may be an estimation of the noise present in the input latent representation, or more generally a noise distribution. In this sense, the direct output may not by a latent representation of an image, but rather of the noise. Using this estimated noise, however, an incrementally denoised image representation may be produced which may be an input to the next iteration of denoising model ε_{θ} 412.

At inference, denoising model se 412 may be used to denoise a latent image representation given a conditioning input 410. Rather than a noisy latent image representation z_{T} 406t, the input to the sequence of denoising models may be a randomly generated vector which is used as a seed. Different images may be generated by providing different random starting seeds. The resulting denoised latent image representation after T denoising model steps may be decoded by a decoder (e.g., decoder 414) to produce an output 416 of a denoised image. For example, conditioning input may include a description of an image, and the output 416 may be an image which is aligned with that description.

Note that while denoising model ε_{θ} 412 is illustrated as the same model being used iteratively, distinct models may be used at different steps of the process. Further, note that a “denoising diffusion model” may refer to a single denoising model se 412, a chain of multiple denoising models se 412, and/or the iterative use of a single denoising model ε_{θ} 412. A “denoising diffusion model” may also include related features such as decoder 414, any pre-processing that occurs to conditioning input 410, etc. This framework 400 of the training and inference of a denoising diffusion model may further be modified to provide improved results and/or additional functionality, for example as in embodiments described herein.

Multi-domain images (e.g., cartoon, art face, real face) domains typically refers to dealing with datasets or scenarios where images belong to different visual styles or categories. Each of these styles-cartoon, art face, and real face-represents a distinct domain, and a multi-domain approach involves developing models that can effectively handle and understand the characteristics of images from each of these domains.

Embodiments described herein address the challenge of multi domains facial landmark detection tasks, such as cartoons and caricatures. Specifically, the main problem solved is the difficulty in achieving accurate facial landmark detection in these alternative domains due to the scarcity of annotated training data. The current face landmark detection methods exhibit satisfactory results for detecting landmarks on real human faces, as shown in the image below. However, when it comes to face landmark detection in other domains such as cartoons, the performance is not as satisfactory.

In some embodiments, a fine-tuning step is performed on a face landmark detection model on the generated dataset, resulting in state-of-the-art performance. An evaluation was conducted on benchmark datasets, such as ArtFace dataset, showcasing the effectiveness of the proposed method across diverse and challenging image domains. Measured metrics include normalized mean error (NME), failure rate (FR), and area under curve (AUC). NME is a widely used standard metric to evaluate landmark accuracy for face alignment algorithms. FR is a metric to evaluate the robustness of algorithms in terms of NME. Samples having larger NME than a pre-defined threshold are regarded as failed prediction. FR is defined by the percentage of failed examples over the whole dataset. AUC is another widely-adopted metric for face alignment task. It can be calculated by using Cumulative Error Distribution (CED) curve. On the NME metric, an embodiment described herein achieved a score of 4.64, while existing alternative methods achieved respective scores of 4.69, 6.5, and 6.2. On the FR metric, an embodiment described herein achieved a score of 2.26, while existing alternative methods achieved respective scores of 3.75, 10.62, and 13.21. On the AUC metric, an embodiment described herein achieved a score of 0.5548, while existing alternative methods achieved respective scores of 0.5388, 0.4573, and 0.5142. In summary, the methods described herein emphasize the novel two-stage training approach, synthetic data generation through a text-to-image diffusion model, flexibility in domain control, dataset creation, and the evaluation of state of the art performance on benchmark datasets.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method of training a facial landmark detector, comprising:
receiving, via a data interface, a training dataset including paired groups of face images, landmarks, and prompts indicating a style of the face images;
training a text to image generation model via a reconstruction loss based on the training dataset;
generating, via the text to image generation model, a synthetic dataset including paired face images and landmarks; and
training the facial landmark detector using a loss function based on the landmarks of the synthetic dataset and a prediction of the facial landmark detector, wherein the prediction of the facial landmark detector is based on the face images of the synthetic dataset.
